(19) United States
(12) Patent Application Publication
(10) Pub. No.: US 2007/0283986 A1
(43) Pub. Date: Dec. 13, 2007

(54) HOME FURNISHING SYSTEM TREATMENT AND METHOD

(76) Inventor: Mark L. Baum, Carlsbad, CA (US)

Correspondence Address: WATCHSTONE P+D, PLC, 1250 CONNECTICUT AVENUE, N.W., SUITE 700, WASHINGTON, DC, 20036-2657, US

(21) Appl. No.: 11/688,133

(22) Filed: Mar. 19, 2007

Related U.S. Application Data
(60) Provisional application No. 60/743,930, filed on Mar. 29, 2006.

(51) Int. Cl. B08B 3/00

(52) U.S. Cl. 134/201; 43/124

(57) ABSTRACT

In some illustrative embodiments, a home furnishing treatment system and method includes: compressively engaging a home furnishing item with an implement to inject hot and cold gases, removing contaminants from the item. Additionally, various embodiments include a vehicle-based system, detachable mobile system, and a portable system for use indoors. Among other things, some embodiments can be used for removing insect pests, such as bed bugs, mites and the like; and for removing allergens, such as mold, pet dander and the like.

### BACKGROUND

1. Field of the Invention

The present invention relates to the removal of pests and/or other contaminants and the cleaning and treatment of home furnishings. Some preferred embodiments provide improved systems and methods for removing pests and/or other contaminants and cleaning of home furnishings based in a vehicle. Other preferred embodiments provide systems that are portable, to treat home furnishings at their locations. Home furnishings, as used in this specification, include but are not limited to, mattresses, bedding, cushions, pillows, and other upholstered items, as well as bed linens (including, e.g., blankets, sheets, pillow cases, etc.) and accessories.

2. Discussion of the Background

While many consumers have pest control services to treat their residences (such as, e.g., for ants, spiders and other household pests), they do not contemplate treatment of home furnishings, which can harbor many undesirable pests and/or other contaminants, including, but not limited to bed bugs and mites. In the past, consumers conducted yearly “spring cleanings”, which helps to some extent to reduce infestations of insects and the like, such as bed bugs, from within homes. However, there are still many pests and contaminants that go unabated or unaddressed. In today's modern society, there is an increasing problem. By way of example, people today tend to travel more frequently, increasing the chances of bringing home certain types of these pests in luggage, on clothing, or in other household items increases. These pests can bring other unwanted diseases, can cause irritating bites, or simply be nuisances unto themselves. Moreover, in today's modern and busy lifestyles, consumers are not able to clean as thoroughly or as often in the past. A reduced level of cleanliness creates an ideal environment for insects and other contaminants to thrive and/or to accumulate.

Previously, a primary means of eradicating these pests was with the application of insecticides. They have several drawbacks. These chemicals are not always desirable or intended to be applied to home furnishings. Damage may result from their application. Consumers may have sensitivities to these chemicals when applied to, for example, mattresses and pillows. Finally, some consumers desire to limit their exposure to chemicals, and insecticides in particular.

Additionally, consumers are becoming increasing aware of allergens and other contaminants within living spaces. Dust, mold, pet dander and the like are causes of discomfort for many consumers. These contaminants are often found in home furnishings, due to their interaction with people, pets, and exposure to the environment. There exist devices and methods for cleaning home furnishings, such as wet vacuums, dry vacuums, and the like, but these methods and devices largely treat the exterior surfaces of the furnishings, leaving the interiors untouched. In addition, these devices do not necessarily kill and/or even catch pests. As a result, the interiors, filled with stuffing, foam, and the like, accumulate allergens (and pests as well). As a consumer sits on a mattress, for example, the compression causes air to be expelled from the mattress, spewing these contaminants and pests into the air, which can cause discomfort to the consumer. It is an advantage of the preferred embodiments of the present invention to treat these contaminants and pests lurking within home furnishings.

While a variety of household pest treatment systems and methods have been known, prior to the present invention, there is a substantial need for a home furnishing pest and/or other contaminant treatment system and method. The present invention provides substantial advances over the limited existing systems and methods, such as, e.g., that described in the following patents: (1) U.S. Pat. No. 4,817,329 entitled Extermination of Insects by Heat which discloses the use of gases at elevated temperatures to kill insects located within structures, is limited to the eradication of insects within walls or floors; (2) U.S. Pat. No. 6,428,801 entitled Methods for Controlling Dust Mites and the Allergens Produced by Dust Mites which discloses an aerosol spray composition to be sprayed on surfaces as a barrier to dust mites, is limited in that it treats only the surfaces of objects, and can include undesirable chemicals; (3) U.S. Pat. No. 6,214,365 entitled Method of Pest Control and Article Useful Therefore which discloses a netting structure used to enclose a mattress or cushion, the netting carries particles of insecticide, is limited in that, among other things, it uses insecticides that to kill insects, their bodies remain, and other inanimate contaminants are not removed; (4) U.S. Pat. No. 5,784,995 entitled Pet Bed which discloses a pet bed with an opening to receive a removable porous cartridge that contains insect repellants and/or deodorants, which is limited in that it only repels, not kills, insects; and does not address contaminants such as allergens.

Prior to the present invention there has been a need in the art for an improved home furnishing treatment system and method.

### SUMMARY OF THE INVENTION

The preferred embodiments of the present invention can significantly improve upon existing methods and/or apparatuses.

According to some embodiments, a home furnishing treating system includes: a vehicle for transporting the treatment system; a treatment device connected to and stored within said vehicle, wherein home furnishings, such as mattresses and/or bedding are treated.

According to some embodiments, a home furnishing pest removal and cleaning system includes: a vehicle with treatment system storage area; a treatment device that is selectively stored within said vehicle; said device is removable from said vehicle; wherein said device is separable from said vehicle by an operator to treat home furnishings, such as mattresses and/or bedding, at remote locations.

In some implementations, the device is installed in the cargo area of a vehicle. The vehicle travels to the customer's location, and bedding materials are brought to the vehicle. The bedding is loaded onto the lower plate of the device; the upper plate is then lowered onto the bedding so as to cause the nozzles to engage the bedding material. The movement of the upper plate and other functions is controlled by the computer control unit. Once the upper plate and nozzles have engaged the bedding material, cold air is injected through a manifold, attached to the upper plate, into the bedding via the upper plate nozzles. After the cold air cycle is complete, hot air in injected in the same manner. Next, the vacuum will be activated to remove insect carcasses and other contaminants from the bedding material. All debris is then removed and stored within the vacuum for later disposal. By this method, the material will be free of insects, as well as allergens, dirt, molds, and other undesirable foreign matter. The upper plate will then be lifted clear of the bedding material, allowing it to be removed and the process can be repeated.

The injection of cold gas into the item, in this example, a bedding mattress, kills insects present in the mattress. It is known that insects cannot withstand extremely cold temperatures. As the cold gas is injected into the mattress, the temperature differential between the mattress and the environment could cause condensation to form within the mattress. To remove any condensation, the following injection of hot gas disperses any undesired moisture from within the mattress.

In order to more easily move the mattress, in the previous example, some embodiments include a mechanism for depositing the mattress on the lower plate. This same mechanism also assists the operator in removing the mattress from the lower plate. In this way, the operator can avoid unnecessary injury when moving large and bulky items, such as mattresses.

In other implementations, the device is more portable in nature, allowing the bedding material to be treated in a more convenient location to the customer. The device includes a belt to wrap around the bedding material, gripping it and pressing the nozzles into the material. The process described above is repeated, with treatments of cold air, hot air, and vacuum suction applied to the material via the belt. The mobility of the device allows materials to be treated quickly, and returned to their previous locations. By including an onboard power source, the device is not limited to the range of electrical cords, but can travel widely unhindered. This feature is particularly desirable when large volumes of materials are to be treated.

In the implementation described above, the portable attribute of the device is especially desirable, such as in a commercial hotel setting, or in an airliner or other mass transportation vehicle. By eliminating the need to transport each home furnishing item to the vehicle, the device can travel about the consumer's location, saving time, money, and disruption. The portable device allows the operator to simply move about the premises treating mattresses, cushions, pillows, and the like. The injection nozzles do not cause any damage to the home furnishing item, yet are large enough to allow for a sufficient volume of gases to flow into the item, and to allow contaminants and dead insects to be suctioned out.

In some illustrative embodiments, systems and methods described herein can be employed in the context of a number of business methodologies.

In one example of such an embodiment, the home furnishing treatment system and method can be offered to consumers by a mattress retailer. The consumer can pay an additional fee at the time of the mattress purchase, a periodic fee, or the treatment(s) can be bundled with the mattress price as a special offer, under the present invention. In this manner, sales of the treatment service can be advantageously affected via retailers. In this manner, a company operating treatment systems can make business arrangements with mattress and/or furnishing retailers to promote the service, and the retailer can attract consumers with offering of such services in advertisements and inducements. It should be appreciated that any retailer could potentially offer such services, such as, e.g., a retailer of chairs, sofas, linen products, carpet cleaning, and/or the like.

In some preferred embodiments, consumers with internet access can visit a website to order home treatment cleaning services under the present invention. The website may provide for the consumer to enter information about the home furnishings to be cleaned, such as, e.g., two queen size beds, one sofa, and/or the like. The consumer can then enter the address, payment information, and other instructions for the company providing the home furnishing treatment service. The consumer data is then directed to the company for an operator service call. Preferably, the operator and/or the operator's vehicle is equipped with an electronic means of communication, such as, e.g., a PDA, or computer whereby the operator can send and receive information such as: 1) consumer location and map; 2) communications with the central dispatch office; 3) review orders; 4) enter consumer orders; and 5) perform other business operations, such as time keeping.

In some preferred embodiments, consumers can telephone to order home treatment cleaning services under the present invention. The telephone call center may provide for the consumer to provide information about the home furnishings to be cleaned, such as, e.g., two queen size beds, one sofa, and/or the like. The consumer can then provide the address, payment information, and other instructions for the company providing the home furnishing treatment service. The consumer data is then directed to the company for an operator service call. Preferably, the operator and/or the operator's vehicle is equipped with an electronic means of communication, such as, e.g., a PDA, or computer whereby the operator can send and receive information such as: 1) consumer location and map; 2) communications with the central dispatch office; 3) review orders; 4) enter consumer orders; and 5) perform other business operations, such as time keeping.

A variety of other business methods and systems can be employed by those in the art.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

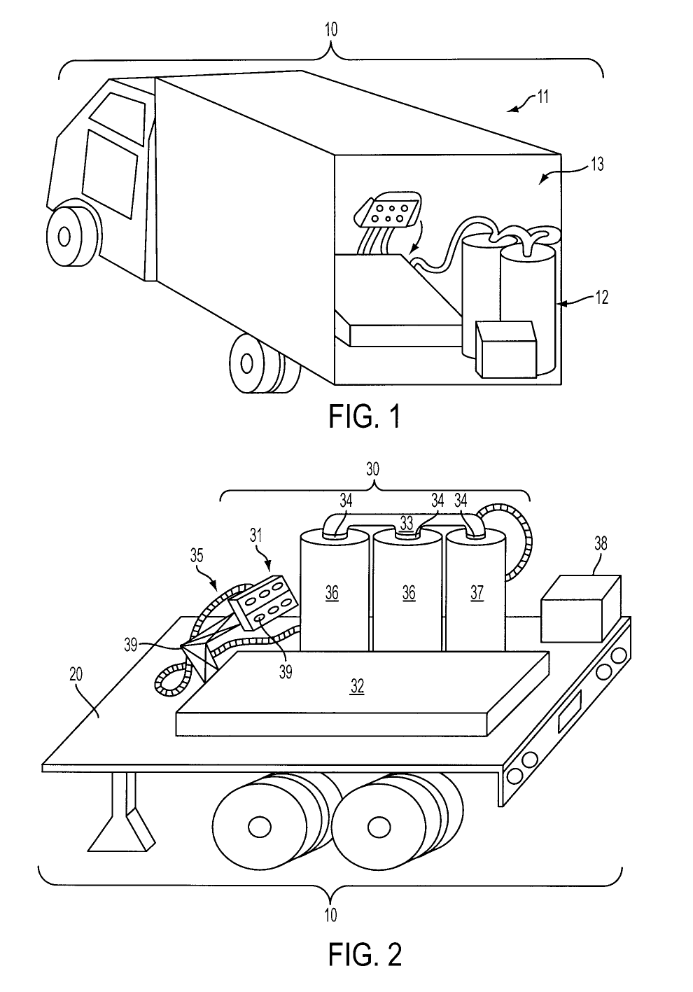

FIG. 1 shows an illustrative example of treatment system 10 that can be employed in some illustrative embodiments of the invention. Vehicle 11 includes treatment device 12 and treatment device storage area 13, which in this embodiment is a closed cargo area. In other embodiments, the treatment device storage area may be on an open trailer (i.e., no sides or top) or a trailer detachable from the vehicle. The vehicle therefore can be a “box truck” vehicle, with a permanently attached box, as shown. In some embodiments, the vehicle can include a vehicle body or body unit (such as, e.g., a trailer or the like) that is attachable to a cab or drive unit (such as, e.g., having a fuel driven motor, a driver area and/or the like). In this regard, in some embodiments, a body unit can be located at a desired location for a period of time (such as, e.g., one or more days, weeks or months) and can be transportable by attachment to a cab or drive unit. In various embodiments, any desired vehicle structure can be used, including, e.g., any presently or future known boats, vans, buses, trucks, automobiles and/or other vehicles or means of transport.

FIG. 2 shows a side view of the vehicle 20 and treatment device 30 on a body unit that can be employed in some illustrative embodiments of the invention. Upper plate 31 is adjustably mounted to support base 32, where home furnishings are placed for treatment. In some embodiments, support base 32 includes a mechanism for easing the placement and removal of home furnishings (such as, e.g., a conveyor belt mechanism, rollers, and/or other mechanisms). In some embodiments, a manifold 33 is connected to a plurality of valves 34.

These in turn are connected to tubing 35, which conveys hot and/or cold gases supply 36 and a suction via a vacuum 37. Preferably, a controller 38 is controllably connected to valves 33, to govern the flow of gases and suction through tubing 35. In some illustrative embodiments, the controller can include a computer, a processor, a PLC and/or any other device for controlling the system. In some embodiments, an articulated arm 39 is used, which forcibly engages the home furnishing item with the upper plate 31, by pivoting about the support base 32.

In the illustrative embodiment shown in FIG. 2, a home furnishing item is treated as follows. The operator places an item on plate 32. Using controller 38, the operator moves plate 31 so as to engage nozzles 39 with the item. The nozzles pierce the item, without causing surface damage. The item is preferably prevented from moving during the treatment cycle. Using the controller, the operator begins the treatment cycle with an injection of cold gases into the item. After a period of time, the cold gas injection ends, and the hot gas injection begins. After another period of time, the hot gas injection ends. At this point, the insects (bed bugs, mites, ticks and the like) are deceased and any moisture generated by the cold gas injection has been removed with the hot gas injection. In order to remove the dead insects, as well as dust, mold, allergens and the like, the operator uses the controller to activate the vacuum. After a period of time, the vacuum is deactivated. The operator releases the plate from the item, and the treatment cycle is completed. This embodiment is just one illustrative treatment method. In other embodiments, cold gases alone can be emitted. In other embodiments, hot gases alone can be emitted. In addition, in other embodiments, the employment of suction can be eliminated. In addition, in other embodiments, the number of cold and/or hot gas treatment steps can be any number from one to more steps.

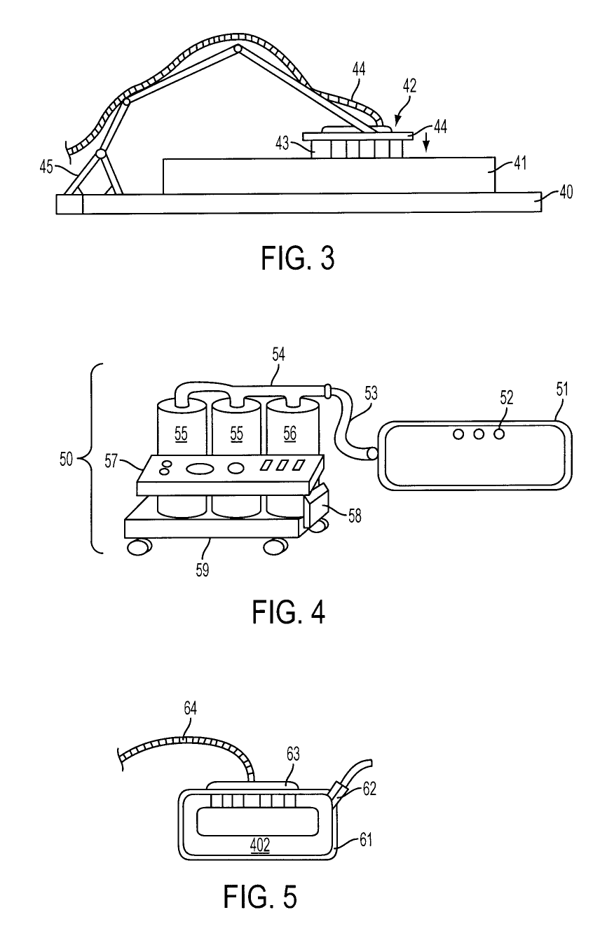

In the embodiment shown in FIG. 3, lower plate 40 is supporting mattress 41. Upper plate 42 includes a plurality of nozzles 43 for piercing the surface of the mattress. Tubing 44 is connected to the upper plate and is conducted along arm 45 to the manifold, hot and/or cold gas supply and vacuum (not shown). The arm articulates to engage a variety of home furnishing items and provides sufficient force to enable the nozzles to penetrate the surface of the mattress, in this example.

FIG. 4 shows a side view of another embodiment of the invention, portable treatment device 50. Belt 51 is used to grip and hold a home furnishing item. Nozzles 52 are connected to the belt, and pierce the item when the belt is compressibly contacted to the item. In some embodiments, the belt is caused to compressibly contact the item manually, such as, e.g., in a manner of a common belt for a pair of pants (e.g., employing a releasable pin and hole engagement). Tubing 53 is connected to the belt and manifold 54. Hot/cold gas supply 55 and vacuum 56 are also connected to the manifold. Controller 57 operates the components of the device, and is powered by power supply 58. The device is contained within cart 59, so as to be mobile and self-sufficient.

In the embodiment shown in FIG. 4, the device is portable. In some embodiments, the device can be contained upon a device to facilitate handling of the device, such as, e.g., upon a wheeled cart. In this manner, the device can be transported to a consumer's home or the like for the treatment of home furnishing items. Among other things, this improves convenience and efficiency for the customer since the customer does not need to have their home furnishings removed from their home for treatment.

In operation, in some embodiments, an operator moves the device to, for example, a bedroom, in order to treat a mattress, bed linens and/or the like. In some embodiments, the belt is removed from the cart and is positioned around the mattress. After firmly securing the belt to the mattress, the treatment cycle begins. Using the controller, the operator begins the cold gas injection into the mattress. After a period of time, the hot gas injection occurs. After the hot gas injection, the insects within the mattress have expired, and are then removed when the operator begins the vacuum cycle. The dead insects and/or other pests and/or other foreign particles or contaminants are removed and deposited within the vacuum for disposal. The cycle concludes when the operator loosens the belt around the mattress and removes it, returning it to the cart.

In the embodiment shown in FIG. 5, home furnishing item 60 (in this example, a cushion) is shown. In this illustrative example, a belt 61 is wrapped around the item and tightened with buckle 62. Upper plate 63 with nozzles, connected to the belt, and is forcibly engaged with the item during the tightening of the belt. Hot and/or cold gas and vacuum suction is applied to the item through tubing 64, which is supplied by the manifold and the remainder of the device (not shown).

In some embodiments, the temperature of the air or gases applied to the devices can be cold air within a temperature range of below about 32 degrees Fahrenheit, or in some embodiments, below about 20 degrees Fahrenheit, or in some embodiments, below about 10 degrees Fahrenheit, or in some embodiments, below about 0 degrees Fahrenheit. In addition, in some embodiments, such cold air or gases can preferably be applied for an extended period of time, such as, e.g., well more than a few minutes, or, in some embodiments, more than a few hours, or, in some embodiments more than about one day. In some embodiments, the temperature of the air or gases applied to the devices can be hot air within a temperature range of more than about 120 degrees Fahrenheit, or, in some embodiments, more than about 150 degrees Fahrenheit, or, in some embodiments, more than about 175 degrees Fahrenheit, or, in some embodiments, more than about 200 degrees Fahrenheit. In addition, in some embodiments, such hot air or gases can preferably be applied for an extended period of time, such as, e.g., well more than a few minutes, or, in some embodiments, more than a few hours, or, in some embodiments more than about one day.

In some other embodiments, the device can be modified so as to treat the contaminants with other forms of discharge (i.e., other than via hot and/or cold gases). By way of example, in some embodiments, the device can emit one or more of the following:
a) high frequency sound (e.g., ultrasound) in a frequency, intensity and time sufficient to kill certain pests or other contaminants;
b) electromagnetic waves (e.g., light, such as, e.g., ultraviolet light) in a frequency, intensity and time sufficient to kill certain pests or other contaminants;
c) lethal gases known for treatment of pests;
d) steam;
e) sprays, dust and/or aerosols known for treatment of pests;

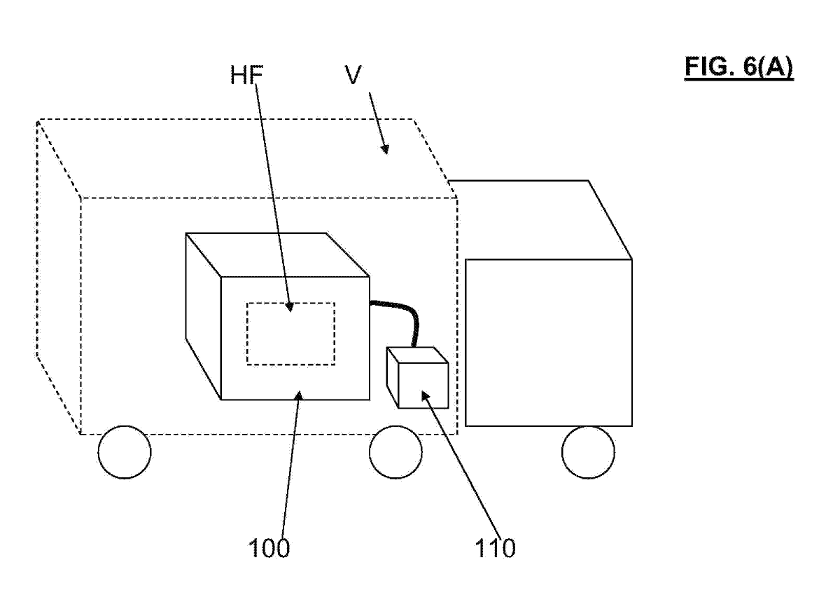

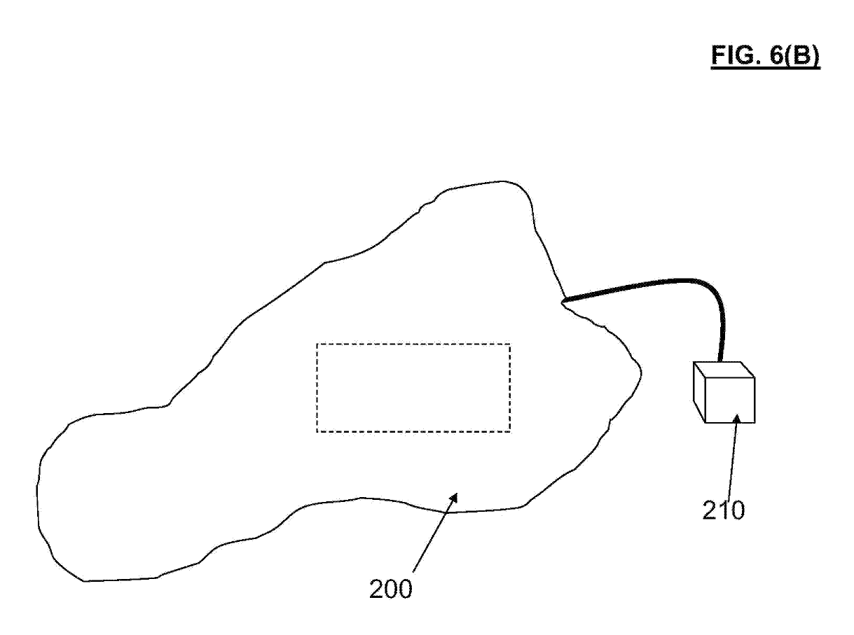

In some embodiments, such as, e.g., shown in FIG. 6(A) the treatment device can involve a large container or box 100 that is located on a vehicle V (such as, e.g., within a truck or the like). As shown, in some embodiments, a unit 110 is provided that is controlled so as to transmit hot gases, cold gases, ultrasound, steam, electromagnetic waves, gases, sprays, dust and/or aerosols (as may be desired depending on the embodiment constructed) into the container or box 100 to treat home furnishings HF as described herein. In some embodiments, rather than having a separate container 100 inside the vehicle V, the entire rear side of the vehicle V (i.e., the trailer portion) can be adapted to act as such a treatment container. In addition, in some embodiments, rather than placing an individual home furnishing in a container, in some embodiments, a plurality of home furnishings are placed within such a container. By way of example, in some embodiments, a truck can collect home furnishings and encase the same inside plastic bags or the like (labeled to identify owners), then the truck can proceed to other locations and can collect many such plastic bags. Preferably, the truck will include a computer or other device to facilitate determination of the proper time period within which to retain the home furnishings. Upon completion of the time period, the truck can return the home furnishings to the customer within the plastic bags.

In some embodiments, with reference to FIG. 6(B), the treatment device can include a discharge unit 210 which is connected to a flexible enclosure 200. In some embodiments, the flexible enclosure can include a large plastic bag or the like. In some embodiments, the assembly can be portably carried into a home and home furnishings can be placed into the flexible enclosure on site. Then, the device can be used, similar to the system shown in FIG. 6(A) to transmit hot gases, cold gases, ultrasound, steam, electromagnetic waves, gases, sprays, dust and/or aerosols (as may be desired depending on the embodiment constructed) into the container or 200 to treat home furnishings HF as described herein.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

I claim:

1. A mattress and/or bedding treatment system, comprising: a) a vehicle; b) a treatment device for eliminating contaminants; c) a treatment device storage area.

2. The treatment system of claim 1, wherein said storage area is inside said vehicle.

3. The treatment system of claim 1, wherein said storage area is outside said vehicle.

4. The treatment system of claim 1, wherein said treatment device is fixed on a trailer of said vehicle.

5. The treatment system of claim 1, wherein said vehicle includes a mechanism for facilitating transfer of mattresses and/or bedding to said vehicle for treatment.

6. The treatment system of claim 1, wherein said treatment includes the treatment of mattresses and/or bedding.

7. The treatment system of claim 1, wherein said treatment includes the treatment of contaminants within mattresses and/or bedding.

8. The treatment of system of claim 1, wherein said treatment includes the treatment of pests within said mattresses and/or bedding.

9. The treatment device of claim 1, said system further comprising an elongated nozzle configured to penetrate a mattress, such nozzle having a passageway configured to transmit a medium into the mattress.

10. The treatment system of claim 1, wherein said vehicle includes communication means for a driver or truck operator to communicate with a dispatch office.

11. A method of treating home furnishings comprising: a) having at least one operator drive a vehicle having a treatment device to a consumer's home location; b) after said step a), using said treatment device to transmit a medium into said home furnishing.

12. The method of claim 11, further including applying a suction to said home furnishing to withdraw said medium and/or contaminants therefrom.

13. The method of claim 11, wherein said home furnishings include mattresses.

14. A mattress and/or bedding treatment system, comprising: a) a vehicle; b) a portable treatment device for eliminating contaminants; c) a portable treatment device storage area.

15. The treatment system of claim 14, wherein said vehicle includes a communication means for a driver or operator to communicate with a dispatch office.

16. The treatment system of claim 14, wherein said treatment includes the treatment of mattresses and/or bedding.

17. The treatment system of claim 14, wherein said treatment includes the removal of contaminants from mattresses and/or bedding.

18. The treatment system of claim 14, wherein said treatment includes the eradication of pests contained in said mattresses and/or bedding.

19. The treatment system of claim 14, wherein said contaminants include allergens.

20. The portable treatment device of claim 14, said device further comprising: a controller for controlling transmission of a medium from said device.

21. The portable treatment device of claim 14, said device further including a plurality of wheels to facilitate handling of said device.

22. The portable treatment device of claim 14, said device further including a power supply.
